(19) United States
(12) Patent Application Publication
(10) Pub. No.: US 2019/0212596 A1
(43) Pub. Date: Jul. 11, 2019

(54) Holographic Material Systems and Waveguides Incorporating Low Functionality Monomers

(71) Applicant: DigiLens, Inc., Sunnyvale, CA (US)

(72) Inventors: Jonathan David Waldern, Los Altos Hills, CA (US); Shibu Abraham, Sunnyvale, CA (US)

(73) Assignee: DigiLens, Inc., Sunnyvale, CA (US)

(21) Appl. No.: 16/007,932

(22) Filed: Jun. 13, 2018

Related U.S. Application Data
(60) Provisional application No. 62/614,813, filed on Jan. 8, 2018.
(60) Provisional application No. 62/614,831, filed on Jan. 8, 2018.

(51) Int. Cl. G02F 1/1334; G02F 1/1337; C09K 19/54; G03H 1/02

(52) U.S. Cl. CPC G02F 1/13342; G02F 1/133711; G03H 2260/12; G03H 1/024; G03H 2001/026; C09K 19/544

(57) ABSTRACT

HPDLC material systems can be formulated in many different ways depending on the application. The HPDLC formulation can include a reactive monomer liquid crystal mixture (“RMLCM”). An RMLCM can include monomer acrylates, multi-functional acrylates, a cross-linking agent, a photo-initiator, and a liquid crystal (“LC”). The mixture (often referred to as syrup) frequently also includes a surfactant. One embodiment includes a reactive monomer liquid crystal mixture material including at least one liquid crystal, a photoinitiator dye, a coinitiators, and photopolymerizable monomers including at least one mono-functional monomer and at least one bi-functional monomer. In some embodiment, the bi-functional monomers accounts for at least 10 weight percent of the reactive monomer liquid crystal mixture material and the at least one mono-functional monomer accounts for at least 30 percent of the reactive monomer liquid crystal mixture material.

### CROSS-REFERENCE TO RELATED APPLICATIONS

The current application claims the benefit of and priority under 35 U.S.C. § 119(e) to U.S. Provisional Patent Application No. 62/614,813 entitled “Low Haze Liquid Crystal Materials,” filed Jan. 8, 2018, and U.S. Provisional Patent Application No. 62/614,831 entitled “Liquid Crystal Materials and Formulations,” filed Jan. 8, 2018. The disclosures of U.S. Provisional Patent Application Nos. 62/614,813 and 62/614,831 are hereby incorporated by reference in their entireties for all purposes.

### FIELD OF THE INVENTION

The present invention generally relates to polymer dispersed liquid crystal material systems and, more specifically, polymer dispersed liquid crystal material systems for use in holographic waveguides.

### BACKGROUND

Waveguides can be referred to as structures with the capability of confining and guiding waves (i.e., restricting the spatial region in which waves can propagate). One subclass includes optical waveguides, which are structures that can guide electromagnetic waves, typically those in the visible spectrum. Waveguide structures can be designed to control the propagation path of waves using a number of different mechanisms. For example, planar waveguides can be designed to utilize diffraction gratings to diffract and couple incident light into the waveguide structure such that the in-coupled light can proceed to travel within the planar structure via total internal reflection (“TIR”).

Fabrication of waveguides can include the use of material systems that allow for the recording of holographic optical elements within the waveguides. One class of such material includes polymer dispersed liquid crystal (“PDLC”) mixtures, which are mixtures containing photopolymerizable monomers and liquid crystals. A further subclass of such mixtures includes holographic polymer dispersed liquid crystal (“HPDLC”) mixtures. Holographic optical elements, such as volume phase gratings, can be recorded in such a liquid mixture by illuminating the material with two mutually coherent laser beams. During the recording process, the monomers polymerize and the mixture undergoes a photopolymerization-induced phase separation, creating regions densely populated by liquid crystal micro-droplets, interspersed with regions of clear polymer. The alternating liquid crystal-rich and liquid crystal-depleted regions form the fringe planes of the grating.

Waveguide optics, such as those described above, can be considered for a range of display and sensor applications. In many applications, a thin, transparent, and lightweight substrate containing one or more grating layers encoding multiple optical functions can be realized using various waveguide architectures and material systems described in the present disclosure, enabling new innovations in near-eye displays for Augmented Reality (“AR”) and Virtual Reality (“VR”), compact Heads Up Displays (“HUDs”) for aviation and road transport, and sensors for biometric and laser radar (“LIDAR”) applications.

### SUMMARY OF THE INVENTION

Material systems for the fabrication of waveguides can include various mixtures formulated for specific applications. One embodiment includes a reactive monomer liquid crystal mixture material including at least one liquid crystal, a photoinitiator dye, a coinitiators, and photopolymerizable monomers including at least one mono-functional monomer and at least one multi-functional monomer.

In another embodiment, the at least one mono-functional monomer includes 2-ethylhexylacrylate.

In a further embodiment, the at least one multi-functional monomer are bi-functional monomers.

In still another embodiment, the bi-functional monomers accounts for at least 2 weight percent of the reactive monomer liquid crystal mixture material.

In a still further embodiment, the bi-functional monomers accounts for at least 10 weight percent of the reactive monomer liquid crystal mixture material and the at least one mono-functional monomer accounts for at least 30 percent of the reactive monomer liquid crystal mixture material.

In yet another embodiment, the at least one liquid crystal accounts for at least 30 weight percent of the reactive monomer liquid crystal mixture material.

In a yet further embodiment, the at least one liquid crystal accounts for at least 35 weight percent and less than 50 weight percent of the reactive monomer liquid crystal mixture material.

In another additional embodiment, the at least one mon-functional monomer includes an adhesion promoter and a compound selected from the group consisting of an aliphatic compound and an aromatic compound.

In a further additional embodiment, the at least one liquid crystal includes high birefringence liquid crystals.

In another embodiment again, the high birefringence liquid crystals have a birefringence of more than 0.2 and accounts for at least 20 weight percent of the reactive monomer liquid crystal mixture material.

A further embodiment again includes a method for recording a volume phase grating, the method includes providing a polymer dispersed liquid crystal mixture sandwiched between two glass substrates, wherein the polymer dispersed liquid crystal mixture includes a reactive monomer liquid crystal mixture material including at least one liquid crystal, a photoinitiator dye, a coinitiators, and photopolymerizable monomers including at least one mono-functional monomer and at least one multi-functional monomer, and exposing the polymer dispersed liquid crystal mixture using an interference pattern to form the volume phase grating.

In still yet another embodiment, the at least one mono-functional monomer includes 2-ethylhexylacrylate.

In a still yet further embodiment, the at least one multi-functional monomer are bi-functional monomers.

In still another additional embodiment, the bi-functional monomers accounts for at least 2 weight percent of the reactive monomer liquid crystal mixture material.

In a still further additional embodiment, the bi-functional monomers accounts for at least 10 weight percent of the reactive monomer liquid crystal mixture material and the at least one mono-functional monomer accounts for at least 30 percent of the reactive monomer liquid crystal mixture material.

In still another embodiment again, the at least one liquid crystal accounts for at least 30 weight percent of the reactive monomer liquid crystal mixture material and the volume phase grating has a diffraction efficiency of higher than 90% and an index modulation of higher than 0.1.

In a still further embodiment again, the at least one liquid crystal accounts for at least 35 weight percent and less than 50 weight percent of the reactive monomer liquid crystal mixture material.

In yet another additional embodiment, the at least one mon-functional monomer includes an adhesion promoter and a compound selected from the group consisting of an aliphatic compound and an aromatic compound.

In a yet further additional embodiment, the at least one liquid crystal includes high birefringence liquid crystals.

In yet another embodiment again, the high birefringence liquid crystals have a birefringence of more than 0.2 and accounts for at least 20 weight percent of the reactive monomer liquid crystal mixture material.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description will be more fully understood with reference to the following figures and data graphs, which are presented as exemplary embodiments of the invention and should not be construed as a complete recitation of the scope of the invention.

FIG. 1 conceptually illustrates a side profile view of a portion of an HPDLC device in accordance with an embodiment of the invention.

FIG. 2A conceptually illustrates a side profile view of a portion of an HPDLC device in operation in accordance with an embodiment of the invention.

FIG. 2B conceptually illustrates a side profile view of a portion of an HPDLC device in a reverse mode operation in accordance with an embodiment of the invention.

FIGS. 3A-3C conceptually illustrate different types of nanoparticles in accordance with various embodiments of the invention.

FIG. 4A conceptually illustrates a polymer dispersed liquid crystal material with a droplet domain containing liquid crystals and nanoparticles in accordance with an embodiment of the invention.

FIG. 4B conceptually illustrates a polymer dispersed liquid crystal material with a planar domain containing liquid crystals and nanoparticles in accordance with an embodiment of the invention.

FIG. 5A is a table showing a formulation of a material system including LC and a mono-functional monomer in accordance with an embodiment of the invention.

FIG. 5B is a table showing a formulation of a material system including LC, a mono-functional monomer, and a multi-functional monomer in accordance with an embodiment of the invention.

FIG. 6A conceptually illustrates a structural formula of a mono-functional monomer in accordance with an embodiment of the invention.

FIG. 6B conceptually illustrates a structural formula of a multi-functional monomer in accordance with an embodiment of the invention.

FIGS. 7A-7C conceptually illustrate the dependence of grating formation on functionality in accordance with various embodiments of the invention.

### DETAILED DESCRIPTION

For the purposes of describing embodiments, some well-known features of optical technology known to those skilled in the art of optical design and visual displays have been omitted or simplified in order to not obscure the basic principles of the invention. Unless otherwise stated, the term “on-axis” in relation to a ray or a beam direction refers to propagation parallel to an axis normal to the surfaces of the optical components described in relation to the invention. In the following description, the terms light, ray, beam and direction may be used interchangeably and in association with each other to indicate the direction of propagation of light energy along rectilinear trajectories. Parts of the following description will be presented using terminology commonly employed by those skilled in the art of optical design. For illustrative purposes, it is to be understood that the Figures are not drawn to scale unless stated otherwise.

Turning now to the drawings, holographic polymer dispersed liquid crystal material systems for holographic waveguide applications are illustrated. HPDLC material systems in accordance with various embodiments of the invention can be formulated in many different ways. In many embodiments, the HPDLC formulation is essentially a reactive monomer liquid crystal mixture (“RMLCM”). An RMLCM can include monomer acrylates, multi-functional acrylates, a cross-linking agent, a photo-initiator, and a liquid crystal (“LC”). The mixture (often referred to as syrup) frequently also includes a surfactant.

For the purposes of describing the invention, a surfactant is defined as any chemical agent that lowers the surface tension of the total liquid mixture. The use of surfactants in PDLC mixtures is known and dates back to the earliest investigations of PDLCs. For example, a paper by R. L Sutherland et al., SPIE Vol. 2689, 158-169, 1996, the disclosure of which is incorporated herein by reference, describes a PDLC mixture including a monomer, photoinitiator, coinitiator, chain extender, and LCs to which a surfactant can be added. Surfactants are also mentioned in a paper by Natarajan et al., Journal of Nonlinear Optical Physics and Materials, Vol. 5 No. I 89-98, 1996, the disclosure of which is incorporated herein by reference. Furthermore, U.S. Pat. No. 7,018,563 by Sutherland et al., claims polymer-dispersed liquid crystal material for forming a polymer-dispersed liquid crystal optical element comprising: at least one acrylic acid monomer; at least one type of liquid crystal material; a photoinitiator dye; a coinitiator; and a surfactant. The disclosure of U.S. Pat. No. 7,018,563 is hereby incorporated by reference in its entirety.

RMLCMs can be formulated with varying compositions of different components. In many embodiments, the RMLCM mixture includes a liquid crystal mixture, a complex mixture of acrylates and acrylate esters, 3-methacryloxypropyltrimethoxysilane (“Dynasylan® MEMO”), and photo-initiators. In further embodiments, the RMLCM includes 2-ethylhexylacrylate (“EHA”) and 2,2,3,3,4,4,5,5,6,6,7,7-Dodecafluoroheptyl acrylate (“DFHA”). In a number of embodiments, low functionality monomers are included in the RMLCM. Such RMLCM mixtures can achieve nearly complete phase separation of the LC material from the polymer, resulting in virtually no observable droplet structure. The latter effect can be confirmed by Scanning Electron Microscope (“SEM”) analysis. In further embodiments, the RMLCM includes mono-functional monomers at about a 30% relative weight ratio and bi-functional monomers at about a 14% relative weight ratio. In such embodiments, the RMLCM yields index modulation of ˜0.12, where the index modulation can be defined as half peak-to-valley refractive index difference, given by (nₑ−nₒ)/2 where nₑ is the extraordinary refractive index and nₒ is the ordinary refractive index. Higher index modulations translate to higher diffraction efficiency (>90%), which can result in more efficient coupling of light into the waveguide and higher brightness and contrast of light extracted from the waveguide. HPDLC material systems and RMLCM formulations are discussed in the sections below in further detail.

### Holographic Waveguide Devices

HPDLC material systems in accordance with various embodiments of the invention can be used in the fabrication processes of various optical devices incorporating waveguides with holographic gratings. One class of gratings used in holographic waveguide devices is the Switchable Bragg Grating (“SBG”). SBGs can be fabricated by first placing a thin film of a mixture of photopolymerizable monomers and liquid crystal material between parallel glass plates. One or both glass plates can support electrodes, typically transparent tin oxide films, for applying an electric field across the film. As described above, a volume phase grating can then be recorded in the film of HPDLC material through photopolymerization-induced phase separation using interferential exposure with a spatially periodic intensity modulation. Factors such as but not limited to control of the irradiation intensity, component volume fractions of the HPDLC material, and exposure temperature can determine the resulting grating morphology and performance. During the recording process, the monomers polymerize and the mixture undergoes a phase separation. The LC molecules aggregate to form discrete or coalesced droplets that are periodically distributed in polymer networks on the scale of optical wavelengths. The alternating liquid crystal-rich and liquid crystal-depleted regions form the fringe planes of the grating, which can produce Bragg diffraction with a strong optical polarization selectivity resulting from the orientation ordering along the grating vector of the LC molecules in the droplets. The volume phase grating can exhibit very high diffraction efficiency, which can be controlled by the magnitude of the electric field applied across the film. When an electric field is applied to the grating via transparent electrodes, the natural orientation of the LC molecules is changed, causing the refractive index modulation of the fringes to reduce and the hologram diffraction efficiency to drop to very low levels. Typically, SBG Elements are switched clear in 30 ps. With a longer relaxation time to switch ON. Note that the diffraction efficiency of the device can be adjusted, by means of the applied voltage, over a continuous range. In many cases, the device exhibits near 100% efficiency with no voltage applied and essentially zero efficiency with a sufficiently high voltage applied. In certain types of HPDLC devices, magnetic fields can be used to control the LC orientation. In some HPDLC applications, phase separation of the LC material from the polymer can be accomplished to such a degree that no discernible droplet structure results. SBGs can also be fabricated by coating an optical recording material onto a substrate which is exposed and then sealed by a protective overcoat layer. In mass production, it can be more efficient and cost effective to replace the traditional two beam holographic recording process described above with one using contact printing from a master. The process can also include the addition of alignment layers for biasing the alignment of LC molecules. In some cases, polarization layers such as half wave and quarter wave films can be added. In some embodiments, the grating in a given layer is recorded in stepwise fashion by scanning or stepping the recording laser beams across the grating area. In many embodiments, SBGs can be fabricated using mastering and contact copying process currently used in the holographic printing industry. Methods for fabricating SBG devices are disclosed in PCT Application No.: PCT/GB2012/000680, entitled IMPROVEMENTS TO HOLOGRAPHIC POLYMER DISPERSED LIQUID CRYSTAL MATERIALS AND DEVICES, the disclosure of which is incorporated herein by reference. This disclosure includes embodiments directed at plastic waveguide devices and SBGs using reverse mode HPDLC.

An SBG can also be used as a passive grating. In this mode, its chief benefit is a uniquely high refractive index modulation. SBGs can also be used to provide transmission or reflection gratings for free space applications. SBGs can be implemented as waveguide devices in which the HPDLC forms either the waveguide core or an evanescently coupled layer in proximity to the waveguide. The parallel glass plates used to form the HPDLC cell (or the substrate and overcoat layers used in other SBG fabrication processes) can provide a total internal reflection (“TIR”) light guiding structure. Light is coupled out of the SBG when the switchable grating diffracts the light at an angle beyond the TIR condition.

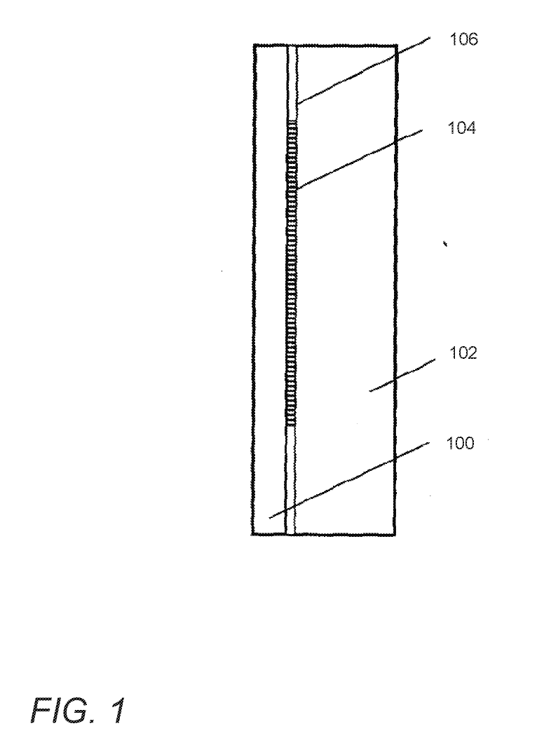

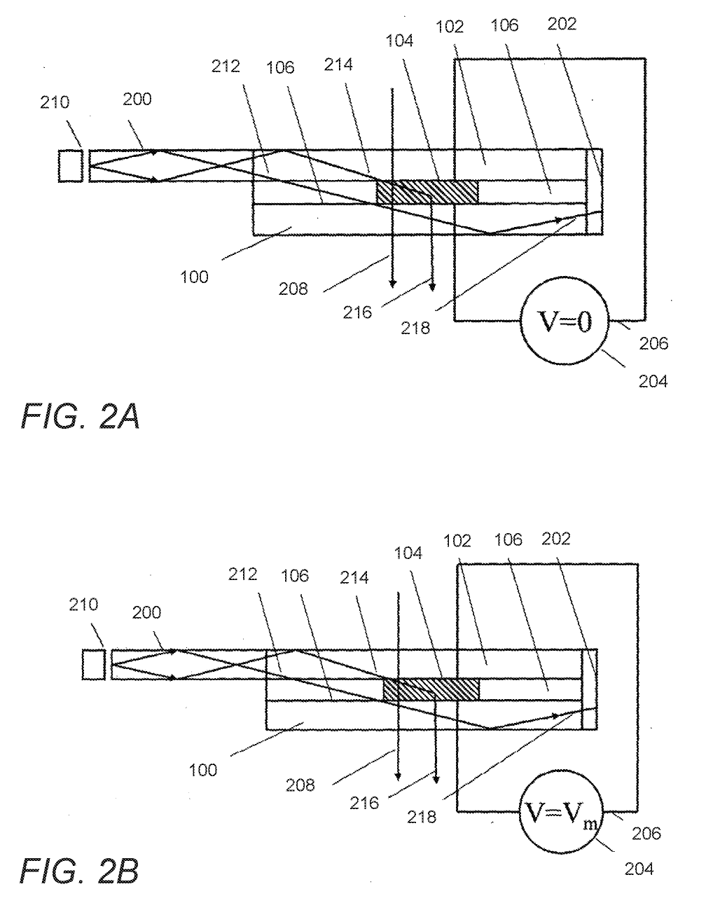

FIGS. 1 and 2A-2B conceptually illustrate holographic waveguide structures in accordance with various embodiments of the invention. As shown in FIG. 1, a holographic waveguide can include a first transparent substrate layer 100, a second transparent substrate layer 102, and an HPDLC layer sandwiched between the two substrates 100, 102 having an RMLCM region 104 containing a grating structure surrounded by pure polymer regions 106. The light guide layer and substrates 100 and 102 together form a light guide. In the illustrative embodiment, the grating structure contains slanted fringes resulting from alternating liquid crystal rich regions and polymer rich (i.e. liquid crystal depleted) regions. The grating structure can be an SBG or a sub-wavelength grating. In many embodiments, a set of transparent electrodes (not shown) can be applied to both of the inner surfaces of the substrates. Typically, the electrodes are configured such that the applied electric field will be perpendicular to the substrates. In a number of embodiments, the electrodes are fabricated from Indium Tin Oxide (“ITO”). In the OFF state with no electric field applied, the extraordinary axis of the liquid crystals generally aligns normal to the Bragg fringes (i.e. along the grating vector). The grating thus exhibits high refractive index modulation and high diffraction efficiency for P-polarized light. When an electric field is applied to the HPDLC, the grating switches to the ON state wherein the extraordinary axes of the liquid crystal molecules align parallel to the applied field and hence perpendicular to the substrate. In the ON state, the grating exhibits lower refractive index modulation and lower diffraction efficiency for both S- and P-polarized light. Thus, the grating region no longer diffracts light. Each grating region can be divided into a multiplicity of grating elements such as for example a pixel matrix according to the function of the HPDLC device. Typically, the electrode on one substrate surface is uniform and continuous, while electrodes on the opposing substrate surface are patterned in accordance to the multiplicity of selectively switchable grating elements.

Turning now to the schematic side elevation view of FIG. 2A, the operation of an SBG device based on the embodiment of FIG. 1 is shown in more detail. It will be seen that the device further includes an input lightguide 200 and a beam stop 202. The region sandwiched between substrates includes at least one RMLCM region 104 containing an SBG and pure polymer regions 106 on either side of the RMLCM region 104. A voltage can be applied across the grating region by means of a voltage source 204 and circuitry indicated schematically by 206. For pixilated SBGs, the circuitry can include an active matrix scheme of the type commonly used in LCDs. In the illustrative embodiment, the grating is in its diffracting state when the applied voltage is zero and is cleared when a voltage is applied. The input lightguide 200 is optically coupled to the substrates 100 and 102 such that the light from the LED undergoes total internal reflection inside the lightguide formed by 100 and 102. External light from other sources generally indicated as 208 propagates through the device and does not interfere with the propagation of light within the lightguide. The propagation of light from the source 210 through the device can be understood by considering the state when the SBG is diffracting, that is with no electric field applied. The rays 212 and 214 emanating from the light source 210 are guided initially by the input lightguide 200. The ray 214, which impinges on the grating region 106, can be diffracted out of the device in the direction 216. On the other hand, the rays 212 which do not impinge on the grating region 106 will hit the substrate-air interface at the critical angle and are totally internally reflected in the direction 218 and eventually collected at the beam stop 202. When an electric field is applied to the SBG, the grating switches to the ON state wherein the extraordinary axes of the liquid crystal molecules align parallel to the applied field and hence perpendicular to the substrate. Note that the electric field due to the planar electrodes is perpendicular to the substrate. Hence, in the ON state the grating exhibits lower refractive index modulation and lower diffraction efficiency for both S- and P-polarized light. Thus, the grating region no longer diffracts light. It should be appreciated that the basic principles of the device illustrated in FIGS. 1 and 2A can be applied in a wide range of different display, optical telecommunications, and sensor applications. FIG. 2B illustrates a reverse mode grating device similar to the one illustrated in FIG. 2A. The grating is in its non-diffracting (cleared) state when the applied voltage is zero and switches to its diffracting stated when a voltage Vm is applied across the electrodes. In conventional cell designs, in addition to these basic components, adhesives and spacers (not shown) can be disposed between the substrates 10 and 40 to affix the layers of the elements together and to maintain the cell gap, or thickness dimension. In these devices, spacers can take many forms, such as but not limited to materials, sizes, and geometries. Materials can include, for example, plastics (e.g., divinylbenzene), silica, and conductive spacers. They can take any suitable geometry, such as but not limited to rods and spheres. The spacers can take any suitable size. In many cases, the sizes of the spacers range from 1 to 30 μm. While the use of these adhesive materials and spacers can be necessary in LC cells using conventional materials and methods of manufacture, they can contribute to the haziness of the cells degrading the optical properties and performance of the waveguide and device.

### HPDLC Material Systems

HPDLC materials in accordance with various embodiments of the invention generally include LC, monomers, photoinitiator dyes, and coinitiators. The patent and scientific literature contains many examples of material systems and processes that can be used to fabricate SBGs, including investigations into formulating such material systems for achieving high diffraction efficiency, fast response time, low drive voltage, and so forth. U.S. Pat. No. 5,942,157 by Sutherland, and U.S. Pat. No. 5,751,452 by Tanaka et al. both describe monomer and liquid crystal material combinations suitable for fabricating SBG devices. Examples of recipes can also be found in papers dating back to the early 1990s, many of which disclose the use of acrylate monomers, including:
R. L. Sutherland et al., Chem. Mater. 5, 1533 (1993), the disclosure of which is incorporated herein by reference, describes the use of acrylate polymers and surfactants. Specifically, the recipe comprises a crosslinking multifunctional acrylate monomer; a chain extender N-vinyl pyrrolidinone, LC E7, photo-initiator rose Bengal, and coinitiator N-phenyl glycine. Surfactant octanoic acid was added in certain variants.
Fontecchio et al., SID 00 Digest 774-776, 2000, the disclosure of which is incorporated herein by reference, describes a UV curable HPDLC for reflective display applications including a multi-functional acrylate monomer, LC, a photoinitiator, a coinitiators, and a chain terminator.
Y. H. Cho, et al., Polymer International, 48, 1085-1090, 1999, the disclosure of which is incorporated herein by reference, discloses HPDLC recipes including acrylates.
Karasawa et al., Japanese Journal of Applied Physics, Vol. 36, 6388-6392, 1997, the disclosure of which is incorporated herein by reference, describes acrylates of various functional orders.
T. J. Bunning et al., Polymer Science: Part B: Polymer Physics, Vol. 35, 2825-2833, 1997, the disclosure of which is incorporated herein by reference, also describes multifunctional acrylate monomers.
G. S. Iannacchione et al., Europhysics Letters Vol. 36 (6). 425-430, 1996, the disclosure of which is incorporated herein by reference, describes a PDLC mixture including a penta-acrylate monomer, LC, chain extender, coinitiators, and photoinitiator.

Acrylates offer the benefits of fast kinetics, good mixing with other materials, and compatibility with film forming processes. Since acrylates are cross-linked, they tend to be mechanically robust and flexible. For example, urethane acrylates of functionality 2 (di) and 3 (tri) have been used extensively for HPDLC technology. Higher functionality materials such as penta and hex functional stems have also been used.

One of the known attributes of transmission SBGs is that the LC molecules tend to align with an average direction normal to the grating fringe planes (i.e. parallel to the grating or K-vector). The effect of the LC molecule alignment is that transmission SBGs efficiently diffract P polarized light (i.e., light with a polarization vector in the plane of incidence), but have nearly zero diffraction efficiency for S polarized light (i.e., light with the polarization vector normal to the plane of incidence).

### Embodiments of S & P Polarized RMLCM Materials

Many embodiments of the invention include reactive monomer liquid crystal mixture (“RMLCM”) material systems configured to incorporate a mixture of LCs and monomers (and other components including: photoinitiator dye, coinitiators, surfactant), which under holographic exposure undergo phase separation to provide a grating in which at least one of the LCs and at least one of the monomers form a first HPDLC morphology that provides a P polarization response and at least one of the LCs and at least one of the monomers form a second HPDLC morphology that provides a S polarization response. In various such embodiments, the material systems include an RMLCM, which includes photopolymerizable monomers composed of suitable functional groups (e.g., acrylates, mercapto-, and other esters, among others), a cross-linking agent, a photo-initiator, a surfactant and a liquid crystal.

Turning to the components of the material formulation, any encapsulating polymer formed from any single photo-reactive monomer material or mixture of photo-reactive monomer materials having refractive indices from about 1.5 to 1.9 that crosslink and phase separate when combined can be utilized. Exemplary monomer functional groups usable in material formulations according to embodiments include, but are not limited to, acrylates, thiol-ene, thiol-ester, fluoromonomers, mercaptos, siloxane-based materials, other esters, etc. Polymer cross-linking can be achieved through different reaction types, including but not limited to optically-induced photo-polymerization, thermally-induced polymerization, and chemically-induced polymerization.

These photopolymerizable materials can be combined in a biphase blend with a second liquid crystal material. Any suitable liquid crystal material having ordinary and extraordinary refractive indices matched to the polymer refractive index can be used as a dopant to balance the refractive index of the final RMLCM material. The liquid crystal material can be manufactured, refined, or naturally occurring. The liquid crystal material includes all known phases of liquid crystallinity, including the nematic and smectic phases, the cholesteric phase, the lyotropic discotic phase. The liquid crystal can exhibit ferroelectric or antiferroelectric properties and/or behavior.

Any suitable photoinitiator, co-initiator, chain extender and surfactant (such as for example octanoic acid) suitable for use with the monomer and LC materials can be used in the RMLCM material formulation. It will be understood that the photo-initiator can operate in any desired spectral band including the in the UV and/or in the visible band.

In various embodiments, the LCs can interact to form an LC mixture in which molecules of two or more different LCs interact to form a non-axial structure which interacts with both S and P polarizations. The waveguide can also contain an LC alignment material for optimizing the LC alignment for optimum S and P performance. In many embodiments, the ratio of the diffraction efficiencies of the P- and S-polarized light in the HPDLC morphology is maintained at a relative ratio of from 1.1:1 to 2:1, and in some embodiments at around 1.5:1. In other embodiments, the measured diffraction efficiency of P-polarized light is from 20% to 60%, and the diffraction efficiency for S-polarized light is from 10% to 50%, and in some embodiments the diffraction efficiency of the HPDLC morphology for P-polarization is around 30% and the diffraction efficiency of the HPDLC morphology for S-polarization is around 20%. This can be compared with conventional HPDLC morphologies where the diffraction efficiency for P-polarization is around 60% and for S-polarization is around 1% (i.e., the conventional P-polarization materials have very low or negligible S-components).

### Mixtures Incorporating Nanoparticles

In many embodiments, the reactive monomer liquid crystal mixture can further include chemically active nanoparticles disposed within the LC domains. In some such embodiments, the nanoparticles are carbon nanotube (“CNT”) or nanoclay nanoparticle materials within the LC domains. Embodiments are also directed to methods for controlling the nanoclay particle size, shape, and uniformity. Methods for blending and dispersing the nanoclay particles can determine the resulting electrical and optical properties of the device. The use of nanoclays in HPDLC is discussed in PCT Application No.: PCT/GB2012/000680, entitled IMPROVEMENTS TO HOLOGRAPHIC POLYMER DISPERSED LIQUID CRYSTAL MATERIALS AND DEVICES.

The nanoclay nanoparticles can be formed from any naturally occurring or manufactured composition, as long as they can be dispersed in the liquid crystal material. The specific nanoclay material to be selected can depend upon the specific application of the film and/or device. The concentration and method of dispersion can also depend on the specific application of the film and/or device. In many embodiments, the liquid crystal material is selected to match the liquid crystal ordinary index of refraction with the nanoclay material. The resulting composite material can have a forced alignment of the liquid crystal molecules due to the nanoclay particle dispersion, and the optical quality of the film and/or device can be unaffected. The composite mixture, which includes the liquid crystal and nanoclay particles, can be mixed to an isotropic state by ultrasonication. The mixture can then be combined with an optically crosslinkable monomer, such as acrylated or urethane resin that has been photoinitiated, and sandwiched between substrates to form a cell (or alternatively applied to a substrate using a coating process).

In various embodiments, nanoparticles are composed of nanoclay nanoparticles, preferably spheres or platelets, with particle size on the order of 2-10 nanometers in the shortest dimension and on the order of 10 nanometers in the longest dimension. Desirably, the liquid crystal material is selected to match the liquid crystal ordinary index of refraction with the nanoclay material. Alternatively, the nanoparticles can be composed of material having ferroelectric properties, causing the particles to induce a ferroelectric alignment effect on the liquid crystal molecules, thereby enhancing the electro-optic switching properties of the device. In another embodiment of the invention, the nanoparticles have an induced electric or magnetic field, causing the particles to induce an alignment effect on the liquid crystal molecules, thereby enhancing the electro-optic switching properties of the device. Examples of nanoparticles used in other contexts including thermoplastics, polymer binders, etc. are disclosed in U.S. Pat. Nos. 7,068,898; 7,046,439; 6,323,989; 5,847,787; and U.S. Patent Pub. Nos. 2003/0175004; 2004/0156008; 2004/0225025; 2005/0218377; and 2006/0142455, the disclosures of which are incorporated herein by reference.

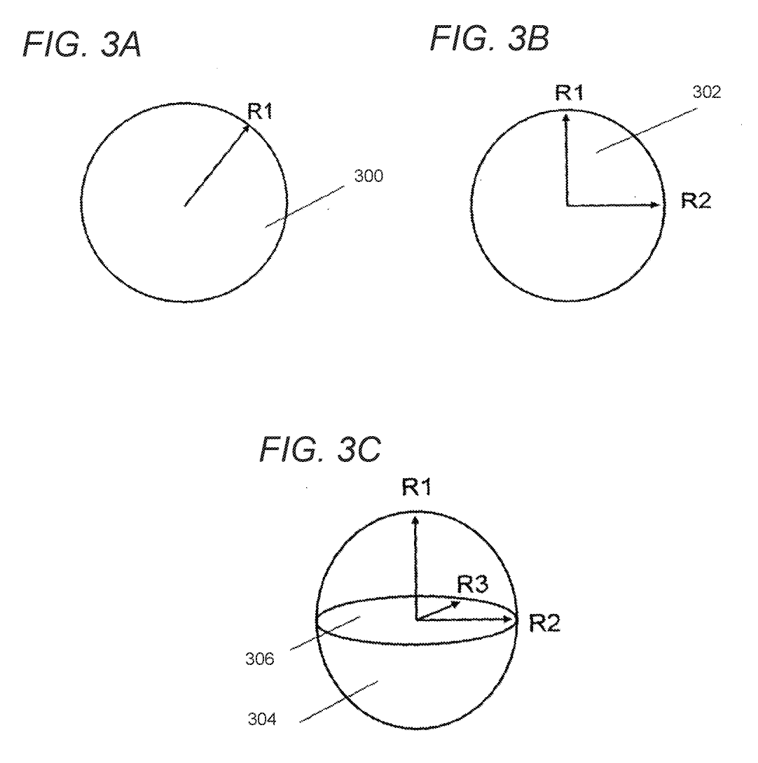

FIGS. 3A-3C provide schematic illustrations of types of nanoparticles in accordance with various embodiments of the invention. FIG. 3A is a schematic of a spherical nanoparticle indicated by 300. The diameter of the nanoparticle 300 is less than one micrometer in all three dimensions. Dimension R1 is less than 0.5 micrometers. This condition results in nanospheres. FIG. 3B is a schematic of a nanoparticle indicated by 302. The nanoparticle 302 is characterized by the dimensions R1 and R2 as shown in FIG. 3B. If R1 is less than R2 and R2 is the radius of a circular cross section, the nanoparticle will be an oblate spheroid. If R1 is greater than R2 and R2 is the radius of a circular cross section, the nanoparticle will be a prolate spheroid. The diameter of the nanoparticle 302 is less than one micrometer in at least one dimension. Either R1 or R2 is less than 0.5 micrometers. This condition results in nanoellipse, nanorod, nanowire, and nanoplatelet configurations. FIG. 3C is a schematic of a nanoparticle indicated by 304. The nanoparticle 304 is a scalene ellipsoid characterized by the dimensions R1, R2 and R3, where the cross section of the plane in which R2 and R3 lie is indicated by 306. The diameter of the nanoparticle 304 is less than one micrometer in at least one dimension. Either R1 or R2 or R3 is less than 0.5 micrometers. This condition results in non-uniform configurations, including some types of nanoplatelets and nanosheets.

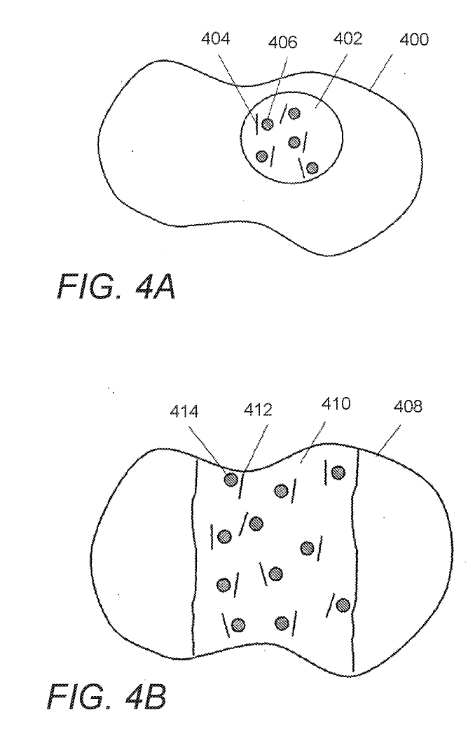

Mixtures incorporating nanoparticles are depicted in FIGS. 4A and 4B. FIG. 4A is a schematic of a polymer dispersed liquid crystal material 400 with a droplet domain 402 containing liquid crystals 404 and nanoparticles 406. FIG. 4B is a schematic of a polymer dispersed liquid crystal material 408 with a planar domain 410 containing liquid crystals 412 and nanoparticles 414.

The nanoclay can be used with its naturally occurring surface properties, or the surface can be chemically treated for specific binding, electrical, magnetic, or optical properties. Preferably, the nanoclay particles will be intercalated, so that they disperse uniformly in the liquid crystalline material. The generic term “nanoclay” as used in the discussion of the present invention can refer to naturally occurring montmorillonite nanoclay, intercalated montmorillonite nanoclay, surface modified montmorillonite nanoclay, and surface treated montmorillonite nanoclay. The nanoparticles can be usable as commercially purchased, or they may need to be reduced in size or altered in morphology. The processes that can be used include chemical particle size reduction, particle growth, grinding of wet or dry particles, milling of large particles or stock, vibrational milling of large particles or stock, ball milling of particles or stock, centrifugal ball milling of particles or stock, and vibrational ball milling of particles or stock. All of these techniques can be performed either dry or with a liquid suspension. The liquid suspension can be a buffer, a solvent, an inert liquid, or a liquid crystal material. One exemplary ball milling process provided by Spex LLC (Metuchen, N.J.) is known as the Spex 8000 High Energy Ball Mill. Another exemplary process, provided by Retsch (France), uses a planetary ball mill to reduce micron size particles to nanoscale particles.

The nanoparticles can be dispersed in the liquid crystal material prior to polymer dispersion. Dry or solvent suspended nanoparticles can be ultrasonically mixed with the liquid crystal material or monomers prior to polymer dispersion to achieve an isotropic dispersion. Wet particles may need to be prepared for dispersion in liquid crystal, depending on the specific materials used. If the particles are in a solvent or liquid buffer, the solution can be dried, and the dry particles dispersed in the liquid crystal as described above. Drying methods include evaporation in air, vacuum evaporation, purging with inert gas like nitrogen and heating the solution. If the particles are dispersed in a solvent or liquid buffer with a vapor pressure lower than the liquid crystal material, the solution can be mixed directly with the liquid crystal, and the solvent can be evaporated using one of the above methods leaving behind the liquid crystal/nanoparticle dispersion. In one embodiment of the invention, the optical film includes a liquid crystal material and a nanoclay nanoparticle, where a nanoparticle is a particle of material with size less than one micrometer in at least one dimension. The film can be isotropically distributed.

Although nanoclay materials are discussed, in many embodiments CNT is used as an alternative to nanoclay as a means for reducing voltage. The properties of CNT in relation to HPDLC devices are reviewed by E. H. Kim et al. in Polym. Int. 2010; 59: 1289-1295, the disclosure of which is incorporated herein by reference in its entirety. HPDLC films have been fabricated with varying amounts of multi-walled carbon nanotubes (“MWCNTs”) to optimize the electro-optical performance of the HPDLC films. The MWCNTs were well dispersed in the prepolymer mixture up to 0.5 wt %, implying that polyurethane acrylate (“PUA”) oligomer chains wrap the MWCNTs along their length, resulting in high diffraction efficiency and good phase separation. The hardness and elastic modulus of the polymer matrix were enhanced with increasing amounts of MWCNTs because of the reinforcement effect of the MWCNTs with intrinsically good mechanical properties. The increased elasticity of the PUA matrix and the immiscibility between the matrix and the liquid crystals gradually increased the diffraction efficiency of the HPDLC films. However, the diffraction efficiency of HPDLC films with more than 0.05 wt % MWCNTs was reduced, caused by poor phase separation between the matrix and LCs because of the high viscosity of the reactive mixture. HPDLC films showing a low driving voltage (75%) could be obtained with 0.05 wt % MWCNTs at 40 wt % LCs.

In embodiments where the HPDLC materials incorporate such nanoparticles, reductions of switching voltage and improvements to the electro-optic properties of a polymer dispersed liquid crystal film and/or polymer dispersed liquid crystal device can be obtained by including nanoparticles in the liquid crystal domains. The inclusion of nanoparticles serves to align the liquid crystal molecules and to alter the birefringent properties of the film through index of refraction averaging. In addition, the inclusion of the nanoparticles improves the switching response of the liquid crystal domains.

### Monomer Functionality

RMLCM material systems in accordance with various embodiments can be formulated in a variety of ways. In many embodiments, the material system is an RMLCM that includes at least one LC, at least one multi-functional monomer, a photo-initiator, a dye, and at least one mono-functional monomer. Along with several factors, such as but not limited to recording beam power/wavelength, grating periodicity, and grating thickness, the specific mixture of components and their percent composition can determine the diffraction efficiency of the resulting HPDLC gratings. Inhomogeneous polymerization due to the spatially periodic irradiation intensity of the exposure can be the driving force to segregate monomers and LCs and to order the orientation of LC molecules, which can influence the diffraction efficiencies of the HPDLC gratings. Oftentimes, the diffusion coefficient of monomers depends on their molecular weight and reactivity. It has been shown that a variety of monomer molecular weights or functional numbers can yield a complex distribution of polymer and LC phases. In many cases, molecular functionality can be critical in achieving efficient phase separation and the formation of gratings with high diffraction efficiency. As such, many embodiments of the invention include material systems formulated with specific mixes of monomers that are chosen, at least in part, for their functionality so as to influence the diffraction efficiency and index modulation of the resulting grating structure. Other considerations in formulating such a mixture can include but are not limited to the properties of the recording beam and the thickness of the gratings. For the purposes of describing this invention, the functionality of a monomer refers to the number of reactive sites on each monomer unit.

The effects of varying monomer functionality in HPDLC material systems have been studied to some degree in the scientific literature. Such studies have generally examined the effects of the effective, or average, functionality of a mixture with regards to grating formation and performance. For example, in a paper by Pogue et al., Polymer 41 (2000) 733-741, the disclosure of which is incorporated herein by reference, investigations were conducted in floodlit PDLCs and holographic PDLC gratings to show that a decrease in effective monomer functionality general leads to decreased LC phase separation.

Many embodiments in accordance with the invention include investigations into mixtures with specific blends of monomers of low functionality that can result in the formation of gratings having high diffraction efficiency and efficient phase separation. While the scientific literature typically emphasizes the use of high functionality monomers, various embodiments in accordance with the invention are focused on the use of monomers of low functionality in certain applications. In some embodiments, the monomers within the mixture are either mono-functional monomers or bi-functional monomers. In a number of embodiments, tri-functional monomers are also included. In such mixtures, the tri-functional monomers are typically included at a low concentration, such as lower than 5 wt %.

Mixtures including low functional monomers can behave differently depending on a variety of factors, such as but not limited to the wavelength sensitivity of the material system, thickness of the HPDLC to be formed, and exposure temperature. In the scientific literature, investigations into PDLC material systems typically include UV sensitive material systems since material reaction efficiency in general is typically poor with visible light systems. However, formulations in accordance with various embodiments of the invention have been able to reach high diffraction efficiency (>80%) with low haze using low functionality monomers that are sensitive (polymerizes) to visible light. In further embodiments, the material systems include monomers that are sensitive to green light, such as light with wavelengths ranging from 495-570 nm. In addition to different light systems, performance of the HPDLC mixtures can depend on the thickness of the waveguide cell in which gratings are formed. For example, for a given material system, different thicknesses of deposited films can form waveguides with different amounts of haze. Although grating thicknesses have been explored in the patent and scientific literature, such investigations are focused on relatively thick gratings. In a number of embodiments, the material system is formulated for use in waveguides with thin form factors. In further embodiments, the material system is formulated for use in manufacturing waveguides having HPDLC layers with thicknesses of less than 10 μm. and gratings with more than 80% diffraction efficiency. In further embodiments, the material system is formulated for use in a waveguide having a 2-3 μm thick HPDLC layer and gratings with 80-90% diffraction efficiency. The material system can also be formulated for manufacturing such waveguides with low haze. In several embodiments, the material system can form HPDLC layers having less than 1% haze. Waveguide haze is the integrated effect of light interacting with material and surface inhomogeneities over many beam bounces. The impact on the ANSI contrast, the ratio of averaged white to black measurements taken from a checker board pattern, can be dramatic owing to the scatter contribution to the black level. Haze is mostly due to wide angle scatter by LC droplets and other small particles or scattering centers resulting from incomplete phase separation of the LC/monomer mixture during grating recording. Haze can also arise, at least partly, from narrow angle scatter generated by large scale nonuniformities, leading to a loss of see-through quality and reduced image sharpness. Some waveguide applications such as aircraft HUDs, which use 1-D beam expansion in thick waveguides, produce as few as 7 bounces, allowing up to 80:1 contrast. However, in thin waveguides of the type use in near eye displays the number of bounces may increase by a factor of 10 making the need for haze control more acute.

RMLCM recipes can be optimized for specific thicknesses of HPDLC layers. In many embodiments, the RMLCM recipe is optimized for a ˜3 μm thick uniform modulation gratings designed to have a refractive index modulation of ˜0.16. As can readily be appreciated, the specific thickness of the waveguide parts to be fabricated can vary and can depend on the specific requirements of a given application. In a number of embodiments, the waveguide parts can be fabricated with 90% transmission and 0.3% haze. In other embodiments, the waveguide parts can be fabricated with ˜0.1% haze (with ˜0.01% haze recorded in unexposed samples of the same material). In some embodiments, the RMLCM can be formulated for fabricating waveguide parts containing haze of less than 0.05%.

Transmission haze can be defined as the percentage of light that deviates from desired beam direction by more the 2.5 degrees on average (according to the ASTM D1003 standard). The clarity of a waveguide can be characterized by the amount of narrow angle scattered light (at an angle less than 2.5° from the normal to the waveguide surface). Transmission can be defined as the amount of light transmitted through the waveguide without being scattered. To assess general material haze, the scatter can be measured around a vector normal to a waveguide TIR surface. To assess holographic haze, the scatter can be measured around principal diffraction directions (passing through the center of the eye box). The procedures for measurement of haze, clarity and transmission are defined in the ASTM D1003 International test standards, in which “Procedure A” uses a haze meter and “Procedure B” uses a spectrophotometer. An exemplary instrument for measuring haze is the BYK-Gardner HAZE Guard II equipment.

In many embodiments, the RMLCM mixture includes a liquid crystal mixture, a complex mixture of acrylates and acrylate esters, Dynasylan® MEMO, and photo-initiators. In further embodiments, the RMLCM includes EHA and DFHA. Depending on the specific mix of components and their percent composition, the resulting grating can have vastly different characteristics. In some embodiments, the proportion of LC by weight is greater than 30%. In further embodiments, the proportion of LC is greater than 35 wt %. In some embodiments, the mixture includes liquid crystal with high birefringence. In further embodiments, the high birefringence liquid crystal accounts for more than 20 wt % of the mixture. In a number of embodiments, dye and photo-initiators account for less than 5 wt % of the mixture.

Nematic LC materials can provide a range of birefringence (which can translate to refractive index modulation). Low to medium birefringence typically covers the range of 0.09-0.12. However, gratings can be designed using much lower birefringence values, including gratings in which the birefringence varies along the grating. Such gratings can be used to extract light from waveguides with low efficiency at one end of the grating and high efficiency at the other end of the grating to provide spatially uniform output illumination. High birefringence (nematic LC) is typically the range of 0.2-0.5. Even higher values are possible. Nematic liquid crystals, compounds, and mixtures with positive dielectric anisotropies (i.e., LCs for which the dielectric constant is greater in the long molecular axis than that in the other directions) are review in a paper by R. Dabrowski et al., “High Birefringence Liquid Crystals”; Crystals; 2013; 3;443-482, the disclosure of which is incorporated herein by reference.

As discussed above, the functionality of the monomers in the mixtures can greatly influence the diffraction efficiency of the resulting grating. In many embodiments, the mixture includes at least one mono-functional monomer and at least one multi-functional monomer in varying concentrations. In several embodiments, the concentration of mono-functional monomer within the mixture ranges from 1-50 wt %. The mono-functional monomer can include aliphatic/aromatic groups and an adhesion promoter. In some embodiments, the proportion of multi-functional monomers present in the mixture is in the range of 2-30 wt %. Multi-functional monomers in accordance with various embodiments of the invention typically include monomers of low functionality. In a number of embodiments, the mixture includes a bi-functional monomer at a low concentration. In further embodiments, the mixture includes bi-functional monomers at less than 15 wt %.

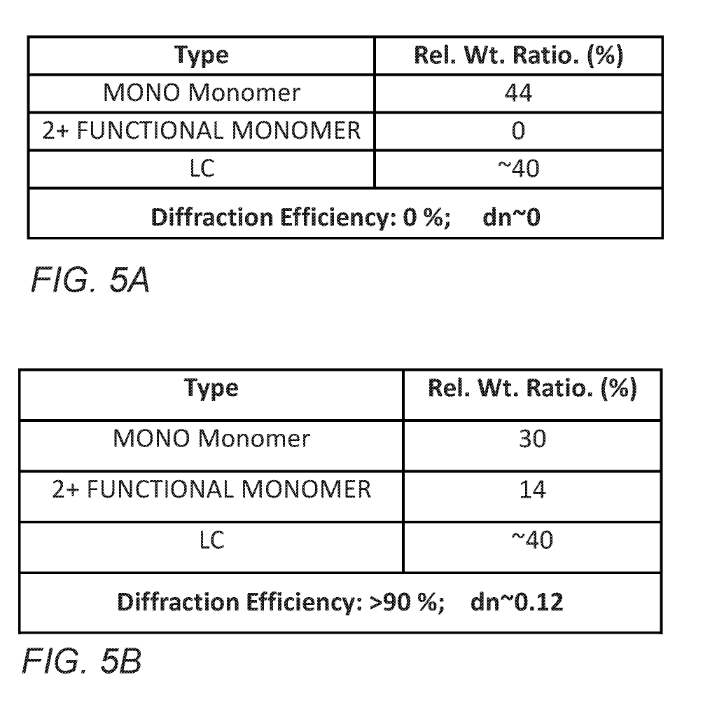

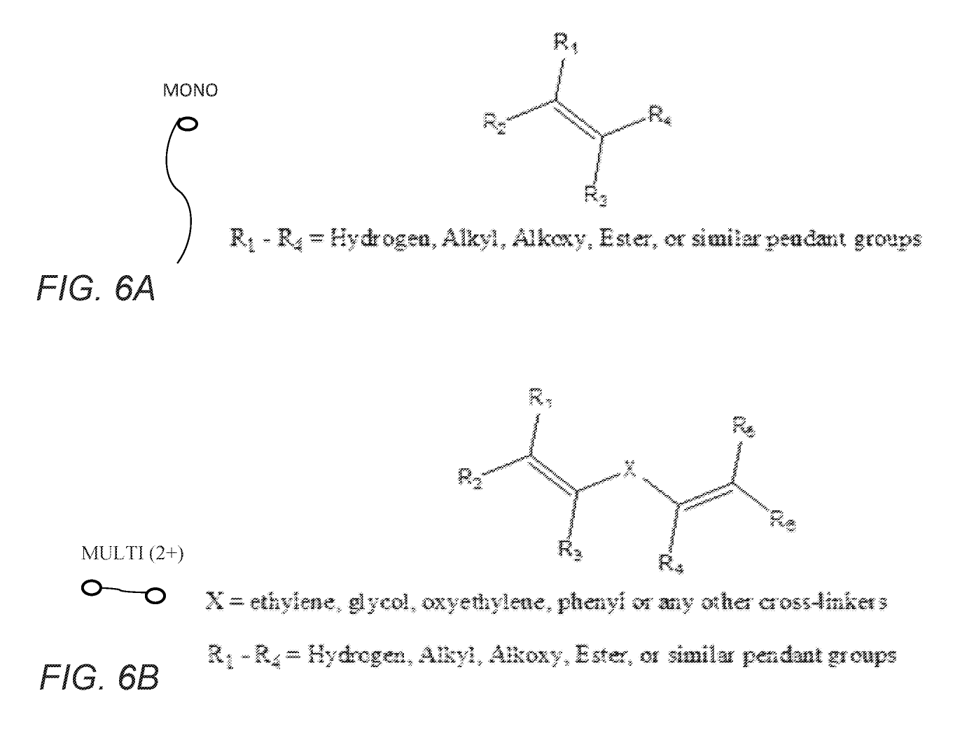

FIG. 5A is a table showing a typical formulation of a material system including LC and a mono-functional monomer. As shown in FIG. 5A, this mixture results in gratings with negligible index modulation and hence no diffraction efficiency. FIG. 5B shows a formulation of a material system in which a multi-functional monomer, in this case a bi-functional monomer, is added to the mixture. Depending on the type and concentration of bi-functional monomer in the mixture, adequate phase separation and grating formation can occur. In the illustrative embodiment, the mono-functional monomer, bi-functional monomer and LC have relative weight ratios of 30%, 14%, and 40%, which resulted in a formulation that allowed for the recording of gratings with a diffraction efficiency higher than 90% and an index modulation of around 0.12. The structural formulas of a typical mono-functional monomer (2-ethyl hexyl acrylate) and a multi-functional monomer are conceptually illustrated in FIGS. 6A and 6B, respectively.

As can readily be appreciated, percent composition of each component within an RMLCM can vary widely. Formulations of such material systems can be designed to achieve certain characteristics in the resulting gratings. In many cases, the RMLCM is formulated to have as high a diffraction efficiency as possible.

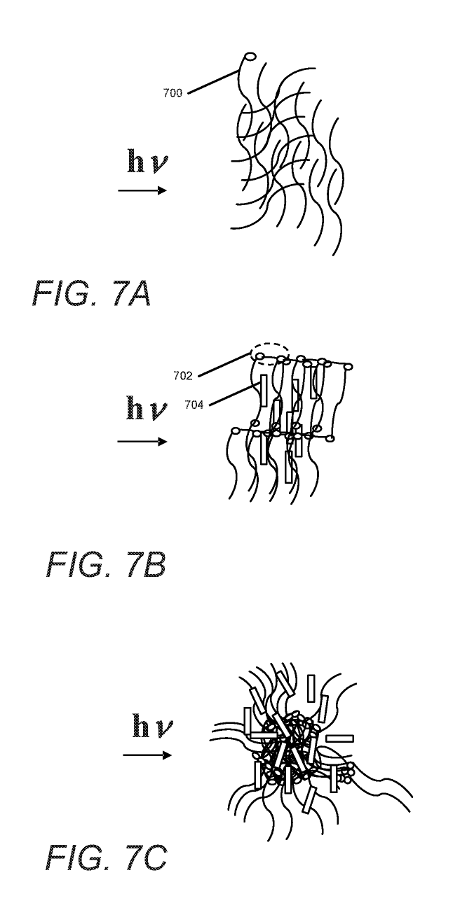

FIGS. 7A-7C conceptually illustrate the dependence of grating formation on functionality in accordance with various embodiments of the invention. Mono-functional systems such as 2-ethyl hexyl acrylate, shown in FIG. 7A, tend to produce shorter chains and show faster chain termination. Incident light energy is represented by the symbols hv. The resulting loosely bound polymer chains 700 inhibit phase separation and grating formation. Mono-functional systems are characterized by random orientations with pendant groups dominating and isotropic phases in the liquid crystalline medium. FIGS. 7B and 7C show mixtures containing multifunctional monomers 702. In such configurations, the polymer binding is stronger and the probability of LC droplets 704 becoming embedded in the polymer matrix is much higher.

Although specific material systems are discussed above, many different formulations can be implemented in accordance with many different embodiments of the invention. It is therefore to be understood that the present invention can be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A reactive monomer liquid crystal mixture material comprising:
at least one liquid crystal;
a photoinitiator dye;
a coinitiator; and
photopolymerizable monomers comprising at least one mono-functional monomer and at least one multi-functional monomer.

2. The reactive monomer liquid crystal mixture material of claim 1, wherein the at least one mono-functional monomer comprises 2-ethylhexylacrylate.

3. The reactive monomer liquid crystal mixture material of claim 1, wherein the at least one multi-functional monomer are bi-functional monomers.

4. The reactive monomer liquid crystal mixture material of claim 3, wherein the bi-functional monomers accounts for at least 2 weight percent of the reactive monomer liquid crystal mixture material.

5. The reactive monomer liquid crystal mixture material of claim 4, wherein:
the bi-functional monomers accounts for at least 10 weight percent of the reactive monomer liquid crystal mixture material; and
the at least one mono-functional monomer accounts for at least 30 percent of the reactive monomer liquid crystal mixture material.

6. The reactive monomer liquid crystal mixture material of claim 5, wherein the at least one liquid crystal accounts for at least 30 weight percent of the reactive monomer liquid crystal mixture material.

7. The reactive monomer liquid crystal mixture material of claim 6, wherein the at least one liquid crystal accounts for at least 35 weight percent and less than 50 weight percent of the reactive monomer liquid crystal mixture material.

8. The reactive monomer liquid crystal mixture material of claim 6, wherein the at least one mon-functional monomer comprises an adhesion promoter and a compound selected from the group consisting of an aliphatic compound and an aromatic compound.

9. The reactive monomer liquid crystal mixture material of claim 6, wherein the at least one liquid crystal comprises high birefringence liquid crystals.

10. The reactive monomer liquid crystal mixture material of claim 9, wherein the high birefringence liquid crystals have a birefringence of more than 0.2 and accounts for at least 20 weight percent of the reactive monomer liquid crystal mixture material.

11. A method for recording a volume phase grating, the method comprising:
providing a polymer dispersed liquid crystal mixture sandwiched between two glass substrates, wherein the polymer dispersed liquid crystal mixture comprises:
a reactive monomer liquid crystal mixture material comprising:
at least one liquid crystal;
a photoinitiator dye;
a coinitiator; and
photopolymerizable monomers comprising at least one mono-functional monomer and at least one multi-functional monomer; and
exposing the polymer dispersed liquid crystal mixture using an interference pattern to form the volume phase grating.

12. The method of claim 11, wherein the at least one mono-functional monomer comprises 2-ethylhexylacrylate.

13. The method of claim 11, wherein the at least one multi-functional monomer are bi-functional monomers.

14. The method of claim 13, wherein the bi-functional monomers accounts for at least 2 weight percent of the reactive monomer liquid crystal mixture material.

15. The method of claim 14, wherein:
the bi-functional monomers accounts for at least 10 weight percent of the reactive monomer liquid crystal mixture material; and
the at least one mono-functional monomer accounts for at least 30 percent of the reactive monomer liquid crystal mixture material.

16. The method of claim 15, wherein:
the at least one liquid crystal accounts for at least 30 weight percent of the reactive monomer liquid crystal mixture material; and
the volume phase grating has a diffraction efficiency of higher than 90% and an index modulation of higher than 0.1.

17. The method of claim 16, wherein the at least one liquid crystal accounts for at least 35 weight percent and less than 50 weight percent of the reactive monomer liquid crystal mixture material.

18. The method of claim 16, wherein the at least one mon-functional monomer comprises an adhesion promoter and a compound selected from the group consisting of an aliphatic compound and an aromatic compound.

19. The method of claim 16, wherein the at least one liquid crystal comprises high birefringence liquid crystals.

20. The method of claim 19, wherein the high birefringence liquid crystals have birefringence of more than 0.2 and accounts for at least 20 weight percent of the reactive monomer liquid crystal mixture material.
